(19) United States
(12) Patent Application Publication
(10) Pub. No.: US 2011/0258572 A1
(43) Pub. Date: Oct. 20, 2011

(54) Service of Controllable Devices through a Control Point

(75) Inventors: Alex Fedosseev, San Jose, CA (US); Cedar Milazzo, San Jose, CA (US); Rodrigo Ramirez, Sunnyvale, CA (US)

(73) Assignee: GENERAL INSTRUMENT CORPORATION, Horsham, PA (US)

(21) Appl. No.: 13/087,959

(22) Filed: Apr. 15, 2011

Related U.S. Application Data
(60) Provisional application No. 61/324,601, filed on Apr. 15, 2010.

(51) Int. Cl. G06F 3/048

(52) U.S. Cl. 715/771

(57) ABSTRACT

In one embodiment, a method determines a virtual kit identifier for a plurality of devices associated with a plurality of entities. The plurality of devices include a control point device and one or more controllable devices. Device profile information for the plurality of devices is stored in a database. The virtual kit identifier is received in a request for service. The method determines device profile information stored in the database for a controllable device. At least a portion of the device profile information including configuration information and graphical user interface display information is sent to a user interface. The user interface uses the graphical user interface display information to cause display of a page using the configuration information. The method connects to the control point device in the plurality of devices to coordinate performing of the service with the controllable device based on information outputted on the page.

### CROSS REFERENCE TO RELATED APPLICATIONS

The present application claims priority to U.S. Provisional App. No. 61/324,601 for “Home Ecosystem Device Information Management System for Maintaining Software and Firmware for Connected Home Devices and Lowering Energy Usage Automatically” filed Apr. 15, 2010, the contents of which is incorporated herein by reference in their entirety.

### BACKGROUND

Particular embodiments generally relate to device management.

In a connected home, a variety of devices may be installed at a customer premise. For example, service providers may deploy services, such as energy management services, that involve a variety of devices to be installed. These devices may be automatically controlled to provide the services. For example, energy management provides a set of features that optimizes energy usage by managing and automatically controlling devices within the customer premise.

The devices providing the service may be manufactured by different entities. This makes installation of the devices difficult and disjointed. For example, the installation process for the devices may be different for each manufacturer. Further, configuring the devices to perform the service may add additional complexity to the installation. For example, actually provisioning the devices with a profile to deploy the energy management service may require additional configuration after installation of the devices.

Accordingly, it is desirable to provide an integrated installation and management of the devices that are associated with different manufacturers and are combined into kits.

### SUMMARY

In one embodiment, a method determines a virtual kit identifier for a plurality of devices associated with a plurality of entities. The plurality of devices include a control point device and one or more controllable devices. Device profile information for the plurality of devices is stored in a database. The virtual kit identifier is received in a request for service. The method then determines device profile information stored in the database for a controllable device in the one or more controllable devices. At least a portion of the device profile information including configuration information and graphical user interface display information is sent to a user interface. The user interface uses the graphical user interface display information to cause display of a page using the configuration information. The method connects to the control point device in the plurality of devices to coordinate performing of the service with the controllable device based on information outputted on the page.

In one embodiment, the method sends device profile information for each of the one or more controllable devices, the device profile information including configuration information and graphical user interface display information for each of the one or more controllable devices. Also, the method connects to the control point device to coordinate performing of the service with each of the one or more controllable devices based on information outputted on the page for each of the one or more controllable devices.

In one embodiment, the user interface includes a generic script configured to execute the graphical user interface display information to display pages for the one or more controllable devices associated with the plurality of entities.

In one embodiment, the plurality of devices communicate using a plurality of communication protocols.

In one embodiment, the plurality of devices operate using a plurality of operational technologies.

In one embodiment, a non-transitory computer-readable storage medium containing instructions for controlling a computer system is provided. The computer system is operable to: determine a virtual kit identifier for a plurality of devices associated with a plurality of entities, the plurality of devices including a control point device and one or more controllable devices; store device profile information for the plurality of devices in a database; receive the virtual kit identifier in a request for service; determine device profile information stored in the database for a controllable device in the one or more controllable devices; send at least a portion of the device profile information including configuration information and graphical user interface display information to a user interface, wherein the user interface uses the graphical user interface display information to cause display of a page using the configuration information; and connect to the control point device in the plurality of devices to coordinate performing of the service with the controllable device based on information outputted on the page.

In one embodiment, an apparatus including one or more computer processors and a computer-readable storage medium including instructions for controlling the one or more computer processors is provided. The instructions control the one or more computer processors to be operable to: determine a virtual kit identifier for a plurality of devices associated with a plurality of entities, the plurality of devices including a control point device and one or more controllable devices; store device profile information for the plurality of devices in a database; receive the virtual kit identifier in a request for service; determine device profile information stored in the database for a controllable device in the one or more controllable devices; send at least a portion of the device profile information including configuration information and graphical user interface display information to a user interface, wherein the user interface uses the graphical user interface display information to cause display of a page using the configuration information; and connect to the control point device in the plurality of devices to coordinate performing of the service with the controllable device based on information outputted on the page.

The following detailed description and accompanying drawings provide a better understanding of the nature and advantages of the present invention.

### BRIEF DESCRIPTION OF THE DRAWINGS

FIG. 1 depicts a system for managing devices in a connected location according to one embodiment.

FIG. 2 shows the formation of a virtual kit according to one embodiment.

FIG. 3 depicts a more detailed example of system according to one embodiment.

FIG. 4 depicts a simplified flowchart of a method for providing service to devices of a virtual kit according to one embodiment.

FIG. 5 depicts a simplified flowchart of a method for performing the service using interface according to one embodiment.

FIG. 6 depicts a simplified flowchart of a method for performing management of a device according to one embodiment.

FIG. 7 depicts a more detailed example of the system to perform the coordination according to one embodiment.

### DETAILED DESCRIPTION

Described herein are techniques for a device management system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

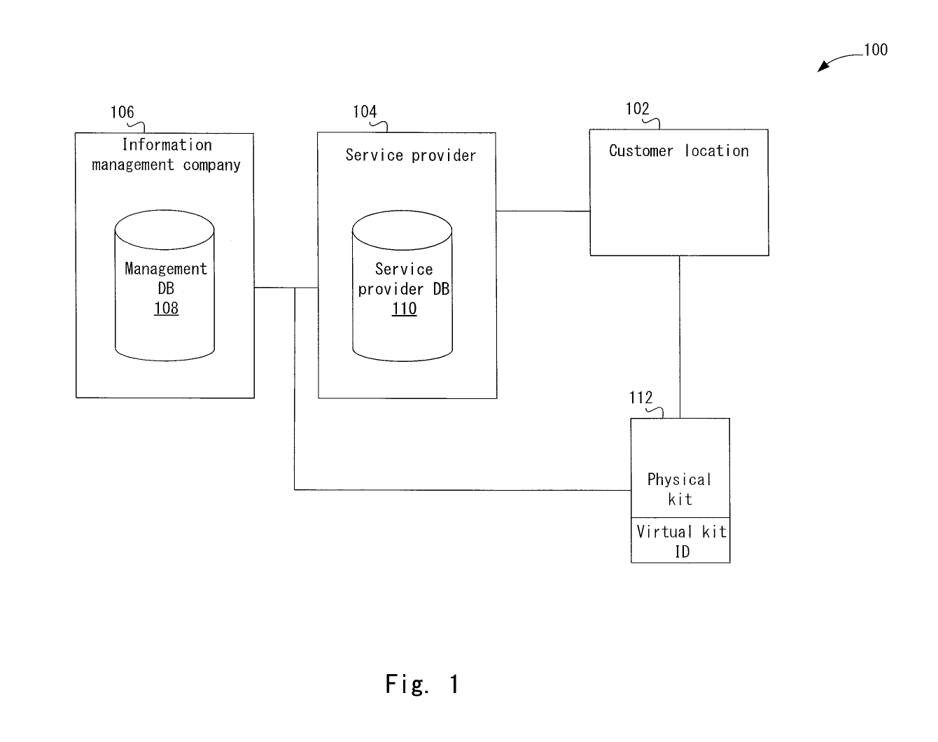

FIG. 1 depicts a system 100 for managing devices in a connected location according to one embodiment. System 100 includes a customer location 102, a service provider 104, and an information management company 106. In one embodiment, customer location 102 is associated with a customer of service provider 104. Additionally, the service provider 104 may contract with information management company 106.

Information management company 106 includes a management database (DB) 108 including device profiles for multiple devices. For example, the devices may be associated with different entities, such as the devices may have been manufactured by or be serviced by different companies. The devices that can be installed at a customer location 102 as connected devices, such as smart meters, programmable thermostats, load control modules, lights, control points, and other controllable devices. These devices may communicate through different protocols and across various networking topologies.

The device profile may include configuration information and graphical user interface display information. The configuration information may include provisioning profiles, a technology type, management attributes, and lifecycle status of a device. The provisioning profiles include information to provision the devices. For example, devices may be provisioned to operate according to a service, such as an energy management service. The technology type may be a version of the device or version of software installed on the device. Management attributes may be information about how to service an installed device. The lifecycle status of a device may be the status of the device profile in a device lifecycle (e.g., tested, certified, and recommended). Graphical user interface display information may be software code that can be executed to cause display of a webpage used in servicing the device.

The types of devices that may be offered by different service providers may vary. For example, service providers 104 may offer different combinations of devices. In one example, a package of devices may be offered to a customer that includes a control point, a camera, and a light. Another package may be a control point, thermostat, and a light. Thus, only a portion of the devices that have profiles stored in database 108 may be needed by a service provider 104.

Particular embodiments provide a virtual kit that is associated with a set of devices and/or services. The set of devices may include devices that are associated with different entities. For example, a camera may have been manufactured by a first manufacturer and a light may have been manufactured by a second manufacturer. The virtual kit may be identified by a virtual kit identifier. In one embodiment, the virtual kit is provided to service provider 104 and can be stored in a service provider database 110. The virtual kit may include device profiles for the set of devices and also the virtual kit identifier.

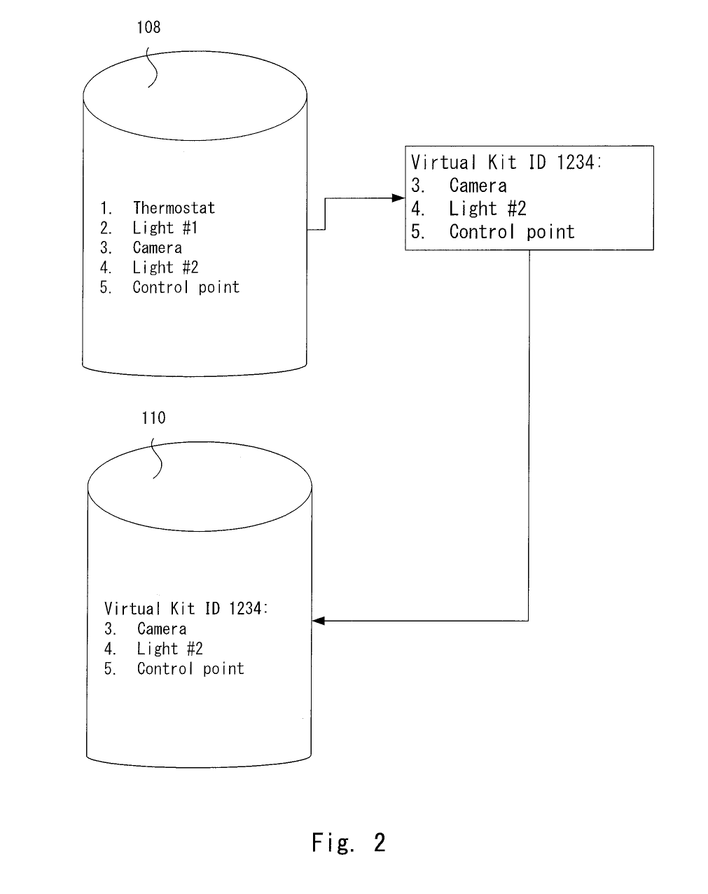

FIG. 2 shows the formation of a virtual kit according to one embodiment. As shown in management database 108, five devices include a thermostat, light #1, camera, light #2, and a control point device. The devices may be manufactured by different entities and operate using different operational technologies (e.g., operating systems) or communicate using different protocols. For each device, a device profile is provided that includes information for the device. For example, the information may include firmware, the update version, protocol used, graphical user interface display information, and other information that is needed for management of the device. The information may describe attributes (e.g., a firmware version) or may include information for the described attribute (e.g., the code for the firmware).

In one example, a virtual kit may be generated with an identifier of “1234”. In this case, the identifier may be added to a section of a database table in database 110. Then, devices may be associated with the virtual kit identifier. In this case, devices of the camera, light #2, and the control point device are associated with the virtual kit.

The virtual kit may then be transferred to service provider database 110. In database 110, the virtual kit identifier is stored along with the device profile information for devices of the virtual kit. Thus, service provider database 110 may not include information for all devices that have been stored in management database 108.

A customer may purchase a physical kit 112 that is associated with the virtual kit. The physical kit includes the physical devices that have been associated with the virtual kit. Additionally, a virtual kit identifier (ID) is also included in the physical kit. A user may obtain the physical device in a set package that includes all the devices. Also, a user may obtain the physical devices separately. The devices may be installed in customer location 102. In one example, the devices include a control point device and a number of controllable devices that are coupled to the control point device. The control point device can automatically control the controllable devices.

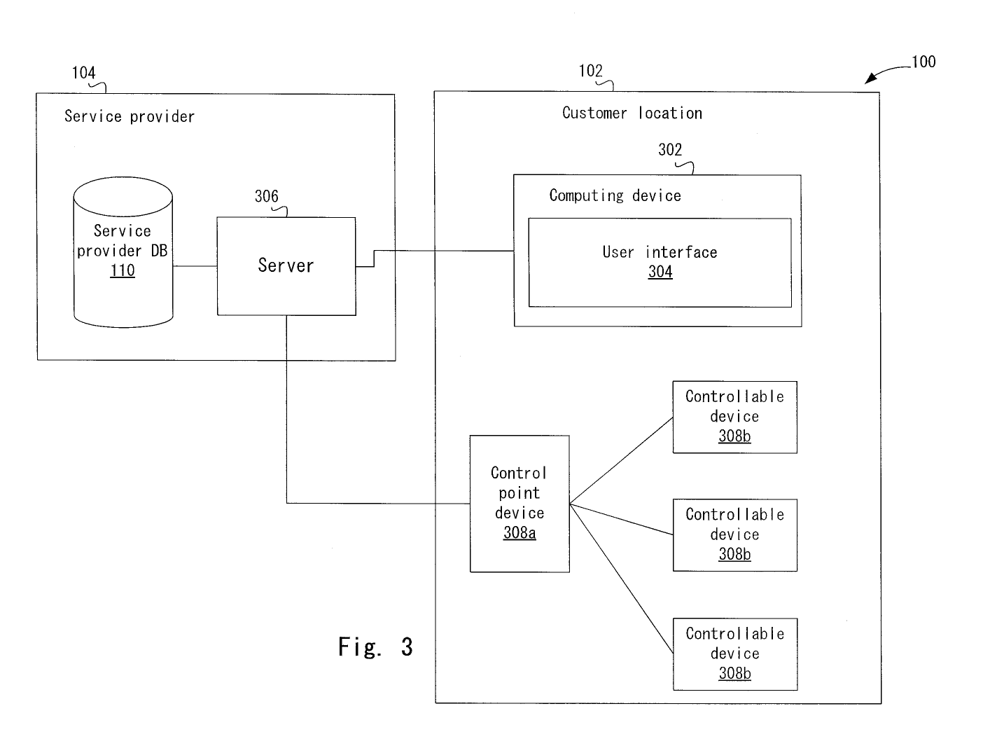

FIG. 3 depicts a more detailed example of system 100 according to one embodiment. As shown, a computing device 302 includes a user interface 304. User interface 304 may be used by a user to interact with service provider database 110 through a server 306. Also, devices 308 (e.g., a control point device 308a and controllable devices 308b) are located in customer location 102.

As will be described in more detail below, a user may provide the virtual kit identifier to service provider 104 through user interface 304. The virtual kit identifier is used to look up information for devices 308 in the virtual kit. Then, a service may be provided to the user. In one example, installation and provisioning of devices 308 may be performed. Also, management and troubleshooting of devices 308 may also be performed. In one example, servicing of controllable devices 308b through control point device 308a may be performed in coordination with information output on user interface 304.

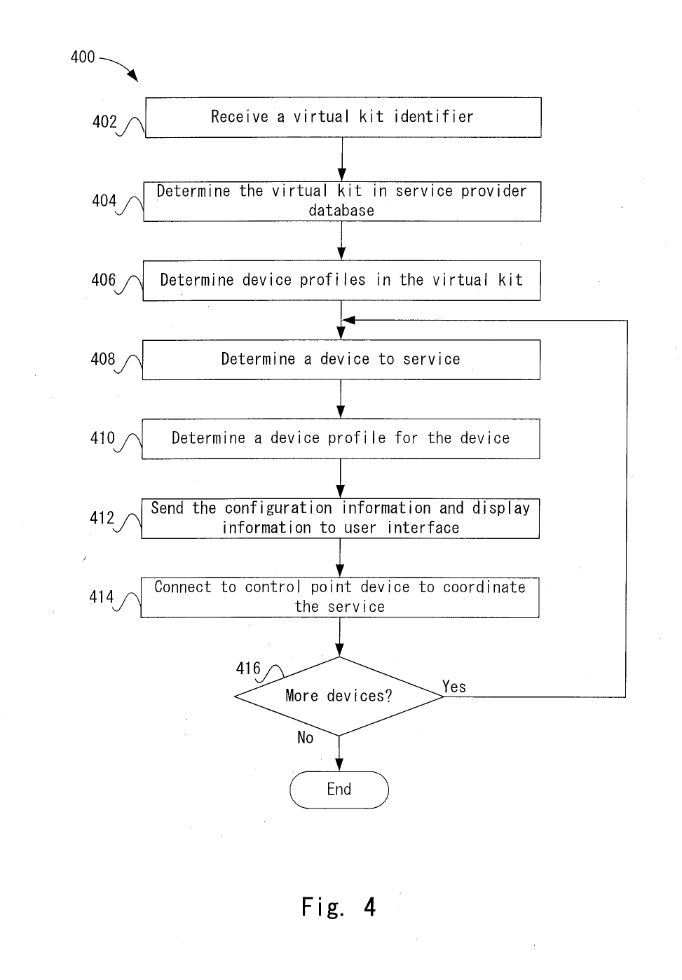

A user may purchase physical kit 112, which includes a set of devices 308. The performing of services for devices 308 may then be performed using a virtual kit identifier in physical kit 112. FIG. 4 depicts a simplified flowchart 400 of a method for providing service to devices 308 of a virtual kit according to one embodiment. At 402, a virtual kit identifier is received. For example, a user may input the virtual kit identifier on user interface 304 and the virtual kit identifier is sent to server 306. The virtual kit identifier may also be received via a customer service call.

At 404, server 306 determines the virtual kit in service provider database 110. For example, service provider database 110 may be queried to retrieve information associated with the virtual kit identifier. Then, at 406, device profiles in the virtual kit are determined.

At 408, a device 308 to service is determined. For example, in an installation situation, all devices may be serviced. The installation process may service devices serially or in parallel. For discussion purposes, it is assumed that one device is serviced at a single time. In other embodiments, a specific device that may be having problems is serviced.

At 410, a device profile for device 308 is determined. In one example, the device profile includes device configuration information and graphical user interface display information. The configuration information may be information about the device. The display information may be software code that is used to display a webpage or a page for the device on user interface 304.

At 412, server 306 sends the configuration information and display information to user interface 304. User interface 304 may use the display information to display a page including the configuration information. As will be described in more detail below, a generic script is used at user interface 304 to execute the display information.

At 414, server 306 connects to control point device 308a to coordinate performing of the service. For example, control point device 308a is leveraged as a proxy to service controllable devices 308b. Control point device 308a can act as a proxy in protocol-agnostic way, e.g. some controllable devices 308b might be using a first protocol, such as Z-Wave, and other controllable devices 308b may be using a second protocol, such as the ZigBee communication protocol, but both types of these controllable devices 308b are still served via one unified abstracted level of proxy communication. In this case, control point device 308a acts as a proxy (or a bridge) between outbound external network (connection to the server 306 though an Internet Protocol (IP) network) and devices on a local network, which may include IP and non-IP devices using various underlying physical connectivity technologies, such as Z-Wave, ZigBee etc. In one embodiment, control point device 308a may perform installation of controllable devices 308b in coordination with information that is displayed on a page on user interface 304. For example, actions that a user should perform with respect to a controllable device 308b may be displayed on user interface 304. When those actions are performed by the user, control point device 308a may confirm the actions are performed or perform another action to install controllable device 308b.

The process to service device 308 may continue through a series of steps. When finished, at 416, it is determined if there are more devices 308 to service. If there are more devices 308, the process reiterates to 408 to determine another device 308 to service. If not, the process ends.

User interface 304 may use the display information from service provider database 110 to display service instructions. User interface 304 may include a generic script that can receive the display information and display the page. Using the generic script allows servicing of devices 308 from different entities. Conventionally, each entity may have had different associated web pages. In particular embodiments, the generic script is used to interpret display information to display the page. Also, updates to the page may be performed easily because the display information is stored in service provider database 110.

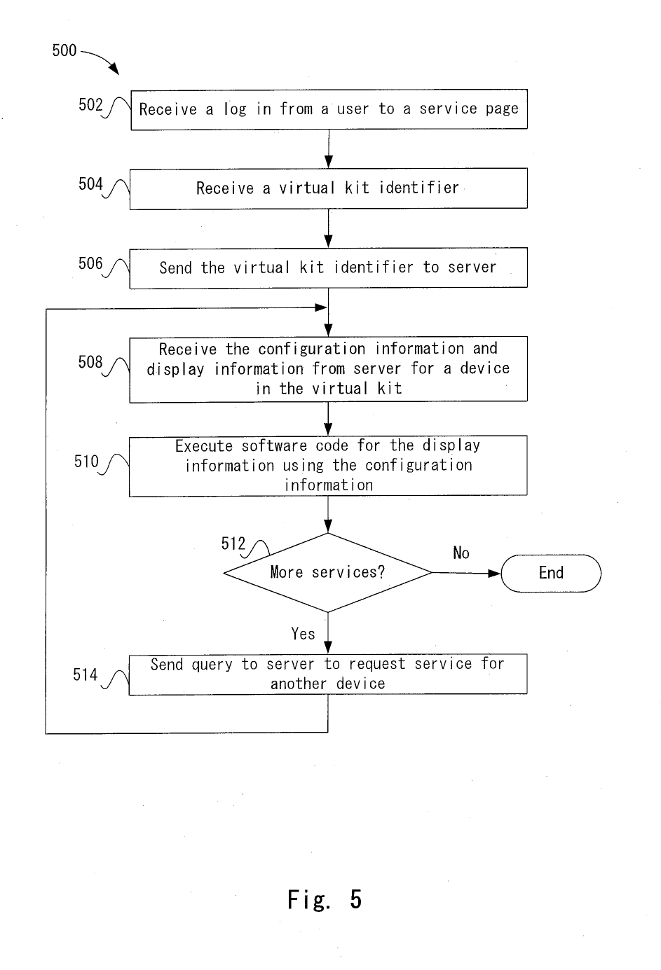

FIG. 5 depicts a simplified flowchart 500 of a method for performing the service using interface 304 according to one embodiment. At 502, user interface 304 receives a log in from a user to a service page for service provider 104.

At 504, user interface 304 receives a virtual kit identifier. For example, a user may input the virtual kit identifier into an entry of user interface 304. At 506, the virtual kit identifier is sent to server 306. Server 306 may then access service provider database 110 as described above.

At 508, user interface 304 receives the configuration information and display information from server 306 for a device 308 in the virtual kit. At 510, user interface 304 executes software code for the display information using the configuration information. For example, a generic script in a page being displayed by user interface 304 is run to execute the display information. The display information causes display of a page (or a panel or section) on user interface 304. The page includes the configuration information. For example, the displayed page includes instructions to perform the service, such as energy management service where the user is presented with the dashboard view of all energy-measuring capable devices in the ecosystem with associated attributes, e.g. current consumption, and information about scenes and schedules that can be utilized for these devices. This process may continue as different steps are performed.

At 512, user interface 304 determines if an additional service needs to be performed. For example, a new device may be serviced. If so, at 514, a query is sent to server 306 to request service for another device. The process may then reiterate to 508 where an additional device 308 is serviced. If an additional device 308 does not need to be serviced, the process may end.

In one embodiment, the service that may be performed includes installation and provisioning of devices 308. In this case, the user may use user interface 304 to receive instructions on the installation and provisioning. For example, a page is displayed requesting that the user perform certain actions with devices 308. The actions that are displayed may be determined from the configuration information received from service provider database 110. In one example, the information may request that the user turn on a device 308, connect device 308 in some manner, or perform some other action, such as selecting certain buttons, on device 308.

In one example, controllable devices 308b are coupled to control point device 308a. Once controllable devices 308b are coupled to control point device 308a, server 306 may communicate through control point device 308a with controllable devices 308b. In this manner, installation and provisioning of control point device 308a and controllable devices 308b may be performed. For example, provisioning may configure certain profiles on controllable devices 308b to control the mode of operation of controllable devices 308b. For example, a home ecosystem is provisioned, such as an energy management profile to reduce energy usage during certain time of the day.

The installation process proceeds as different pages or information on pages may be displayed on user interface 304 requesting actions to be performed by the user. This is coordinated with server 306 connecting to control point device 308a and controllable devices 308b to provide the installation and provisioning. For example, when an action is performed at one of control point device 308a or controllable devices 308b, that action may be confirmed by server 306 or an additional action may be performed.

After installation and provisioning, management of a device may be performed. For example, management may include troubleshooting of problems occurring at one of devices 308.

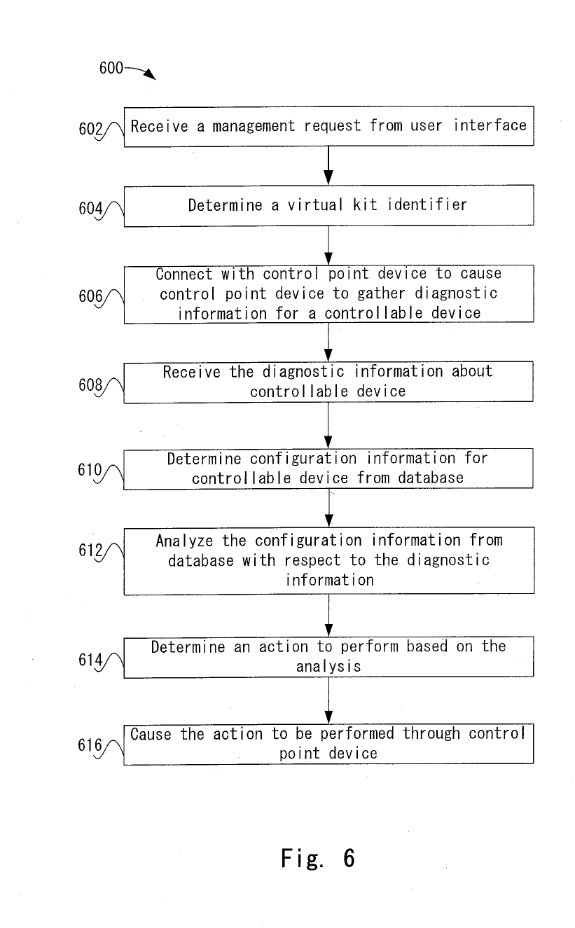

FIG. 6 depicts a simplified flowchart 600 of a method for performing management of a device 308 according to one embodiment. The management of a single device 308 is described, but multiple devices 308 may be managed simultaneously or sequentially.

At 602, server 306 receives a management request from user interface 304. The management request may also be received through other methods, such as through a telephone call or a trigger initiated by a management system at service provider 104.

At 604, server 306 determines a virtual kit identifier. In one example, the management request may include a virtual kit identifier (e.g., the virtual kit identifier is input by a user). In other embodiments, the virtual kit identifier may be associated with other information, such as a user identifier or user login information. For example, the user login information that is received with the management request may be used to determine a virtual kit identifier for this specific user.

At 606, server 306 connects with control point device 308a to cause control point device 308a to gather diagnostic information for a controllable device 308b. For example, control point device 308a may retrieve configuration information for software/hardware installed on controllable device 308b. The configuration information may include the version of an operating system installed on controllable device 308b, a firmware version, or the version of hardware in controllable device 308b. Other diagnostic information may also be retrieved, such as tests may be run on controllable device 308b to determine the diagnostic information.

At 608, server 306 receives the diagnostic information about controllable device 308b. At 610, server 306 determines configuration information for controllable device 308b from database 110. In a device lifecycle, the different stages may cause changes to information in database 110. Thus, as devices 308 go through the register, test, certify, recommend, and end-of-life stages, different information may be updated in database 110. In one example, the versions of software that are considered current may be changed.

At 612, server 306 analyzes the configuration information from database 110 with respect to the diagnostic information. The analysis may include comparing the version of software installed on controllable device 308b to the preferred version stored in database 110. If differences result, then this may be a point of troubleshooting. Other troubleshooting may also be performed. For example if server 306 receives information indicating presence of conflicting controllable devices 308b within the home ecosystem (e.g., customer location 102), such as controllable devices 308b with overlapping in radio frequency or improperly configured controllable devices 308b with inconsistent settings between control point device 308a—server 306 sends a message via either user interface 304 or attempts to resolve the problem automatically by applying the correct configuration profile and logging the results of the operation for future audit.

At 614, server 306 determines an action to perform based on the analysis. For example, the configuration information in database 110 may define certain actions to be performed based on the analysis. In one example, if a version of software is out of date on controllable device 308, then an action to install a new version of the software is performed. In another example, new individual device 308 settings or a collective virtual kit configuration profile (as a set of individual device 308 profiles) may be applied.

At 616, server 306 causes the action to be performed through control point device 308a. For example, control point device 308a is contacted to control controllable device 310a to perform the action. In one example, the installation of an updated version of the software may be performed on controllable device 308b.

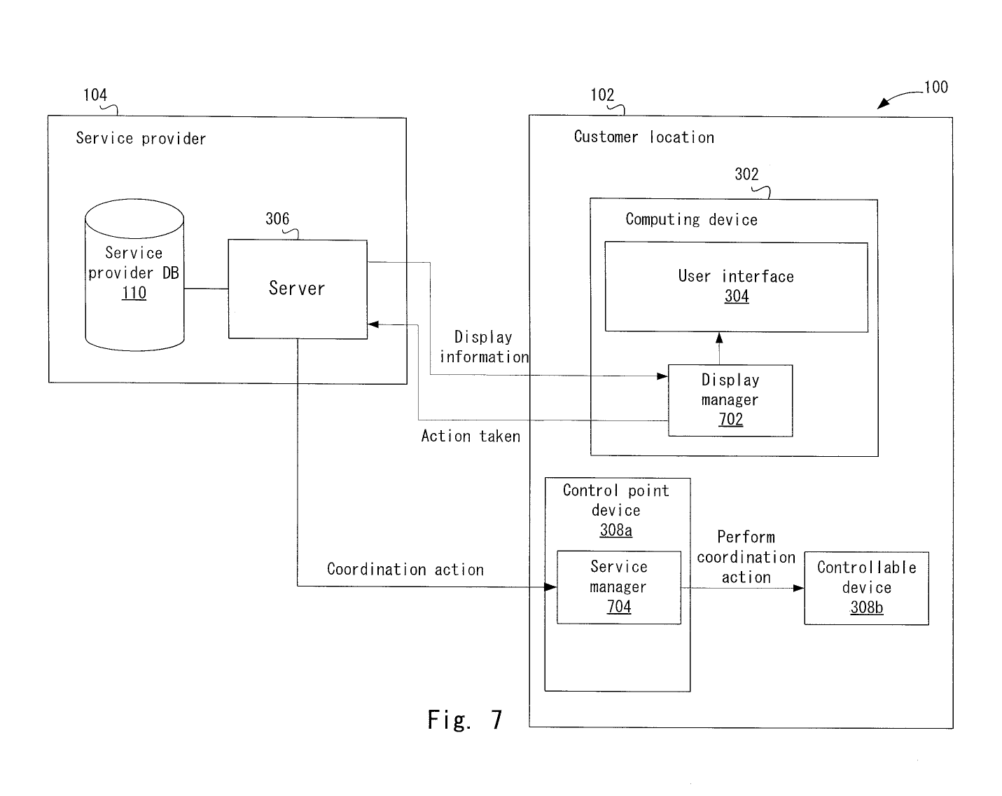

As discussed above, coordination between user interface 304 and control point device 308a is performed. FIG. 7 depicts a more detailed example of system 100 to perform the coordination according to one embodiment. A display manger 702 of computing device 302 is used to display a page using display information and configuration information received from server 306. An input is received from user interface 304 indicating that an action has been taken by a user. For example, the page may ask a user to turn on a device 308 and then select a “Next” button. Display manager 702 then sends an indication to server 306 that an action has been taken.

Server 306 then determines what coordination action needs to be performed based on the action taken by the user. For example, information from database 110 may be used to determine which coordination action to perform. A series of steps may be stored and when a “Next” button is selected, a coordination action in the step is performed. At that point, server 306 sends the coordination action to control point device 308a.

A service manager 704 of control point device 308a is used to perform the coordination action. For example, service manager 704 communicates with controllable device 308b to have the coordination action performed. In this way, control point device 308a is used as a proxy to coordinate the performing of a service between user interface 304 and device 308b.

Particular embodiments provide many advantages. For example, proxy style remote management, provisioning, diagnostics, troubleshooting, monitoring, and upgrading may be performed. In one use case, provisioning a controllable device 308b or a group of controllable devices 308b via a device profile is performed to change the mode of operation of devices 308b to allow energy savings. This may be associated with utility driven demand response as well as user driven savings scenarios.

The management of controllable devices 308 is universal (e.g. device and protocol agnostic) and applies to Internet protocol (IP) and non-IP devices regardless of underlying layer two connectivity/technology with respect to control point device 308a. For example, controllable devices 308b may not need to be coupled to control point device 308a to have the service performed. However, to coordinate the performing of the service, it may be desirable to have controllable device 308b coupled to control point device 308a.

Also, particular embodiments provide a generic interface that can use display information to display a page. In this way, web pages may not be hard-coded to coordinate installation of devices 302. When the installation changes, the display information in database 110 may be changed. However, the software code for user interface 304 does not need to be changed. Rather, the same generic interface is used to interpret the display information and display a new page. This also allows generic user interface 304 to provide installation for devices 302 of different manufacturers. Rather than having different pages hard-coded for different manufacturers, the same generic user interface 304 may be used to interpret different display information.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining a virtual kit identifier for a plurality of devices associated with a plurality of entities, the plurality of devices including a control point device and one or more controllable devices;
storing device profile information for the plurality of devices in a database;
receiving the virtual kit identifier in a request for service;
determining device profile information stored in the database for a controllable device in the one or more controllable devices;
sending at least a portion of the device profile information including configuration information and graphical user interface display information to a user interface, wherein the user interface uses the graphical user interface display information to cause display of a page using the configuration information; and
connecting to the control point device in the plurality of devices to coordinate performing of the service with the controllable device based on information outputted on the page.

2. The method of claim 1, further comprising:
sending device profile information for each of the one or more controllable devices, the device profile information including configuration information and graphical user interface display information for each of the one or more controllable devices; and
connecting to the control point device to coordinate performing of the service with each of the one or more controllable devices based on information outputted on the page for each of the one or more controllable devices.

3. The method of claim 2, further comprising performing the sending and the connecting for a plurality of different service steps for a controllable device, wherein different information is outputted on the page and different actions are performed in the different service steps.

4. The method of claim 1, wherein the user interface comprises a generic script configured to execute the graphical user interface display information to display pages for the one or more controllable devices associated with the plurality of entities.

5. The method of claim 4, further comprising changing configuration information and graphical user interface display information for a controllable device, wherein the generic script is not changed to display a different page to service the controllable device.

6. The method of claim 1, further comprising provisioning the one or more controllable devices through the control point device based on the device profile information.

7. The method of claim 6, wherein provisioning comprises setting a mode of operation of the one or more controllable devices for energy management.

8. The method of claim 1, further comprising:
querying the control point device for diagnostic information for the controllable device;
receiving the diagnostic information for the controllable device; and
analyzing the diagnostic information and the device profile information for the controllable device to determine an action to perform with the controllable device.

9. The method of claim 8, further comprising communicating with the control point device to the have the action automatically performed with the controllable device.

10. The method of claim 1, wherein the plurality of devices communicate using a plurality of communication protocols.

11. The method of claim 1, wherein the plurality of devices operate using a plurality of operational technologies.

12. A non-transitory computer-readable storage medium containing instructions for controlling a computer system to be operable to:
determine a virtual kit identifier for a plurality of devices associated with a plurality of entities, the plurality of devices including a control point device and one or more controllable devices;
store device profile information for the plurality of devices in a database;
receive the virtual kit identifier in a request for service;
determine device profile information stored in the database for a controllable device in the one or more controllable devices;
send at least a portion of the device profile information including configuration information and graphical user interface display information to a user interface, wherein the user interface uses the graphical user interface display information to cause display of a page using the configuration information; and
connect to the control point device in the plurality of devices to coordinate performing of the service with the controllable device based on information outputted on the page.

13. The computer-readable storage medium of claim 12, operable to:
send device profile information for each of the one or more controllable devices, the device profile information including configuration information and graphical user interface display information for each of the one or more controllable devices; and
connect to the control point device to coordinate performing of the service with each of the one or more controllable devices based on information outputted on the page for each of the one or more controllable devices.

14. The computer-readable storage medium of claim 12, wherein the user interface comprises a generic script configured to execute the graphical user interface display information to display pages for the one or more controllable devices associated with the plurality of entities.

15. The computer-readable storage medium of claim 14, further operable to change configuration information and graphical user interface display information for a controllable device, wherein the generic script is not changed to display a different page to service the controllable device.

16. The computer-readable storage medium of claim 12, further operable to provision the one or more controllable devices through the control point device based on the device profile information.

17. The computer-readable storage medium of claim 12, further operable to:
query the control point device for diagnostic information for the controllable device;
receive the diagnostic information for the controllable device; and
analyze the diagnostic information and the device profile information for the controllable device to determine an action to perform with the controllable device.

18. The computer-readable storage medium of claim 12, wherein the plurality of devices communicate using a plurality of communication protocols.

19. The computer-readable storage medium of claim 12, wherein the plurality of devices operate using a plurality of operational technologies.

20. An apparatus comprising:
one or more computer processors; and
a computer-readable storage medium comprising instructions for controlling the one or more computer processors to be operable to:
determine a virtual kit identifier for a plurality of devices associated with a plurality of entities, the plurality of devices including a control point device and one or more controllable devices;
store device profile information for the plurality of devices in a database;
receive the virtual kit identifier in a request for service;
determine device profile information stored in the database for a controllable device in the one or more controllable devices;
send at least a portion of the device profile information including configuration information and graphical user interface display information to a user interface, wherein the user interface uses the graphical user interface display information to cause display of a page using the configuration information; and
connect to the control point device in the plurality of devices to coordinate performing of the service with the controllable device based on information outputted on the page.
